(19) United States
(12) Patent Application Publication
(10) Pub. No.: US 2010/0067325 A1
(43) Pub. Date: Mar. 18, 2010

(54) System and Method for Collecting Seismic Information

(76) Inventors: Yuefeng Sun, College Station, TX (US); Karl-Andreas Berteussen, Abu Dhabi (AE)

Correspondence Address: BAKER BOTTS L.L.P., 2001 ROSS AVENUE, SUITE 600, DALLAS, TX, 75201-2980, US

(21) Appl. No.: 12/556,426

(22) Filed: Sep. 9, 2009

Related U.S. Application Data
(60) Provisional application No. 61/095,529, filed on Sep. 9, 2008.

(51) Int. Cl. G01V 1/38

(52) U.S. Cl. 367/15

(57) ABSTRACT

A system and method for collecting seismic information is disclosed. In one embodiment, the method includes transmitting a first pressure wave from a first location towards a floor of a body of water, wherein the first location is in close proximity to the floor. The method also includes receiving a first reflected wave at a second point, wherein the first reflected wave comprises a reflection of the first pressure wave by a reflection point beneath the floor. The method also includes receiving a second reflected wave at the second point, wherein the second reflected wave comprises a reflection of a shear wave generated as a result of the first pressure wave striking the floor.

### RELATED APPLICATIONS

This application claims the benefit of U.S. Provisional Application No. 61/095,529 filed Sep. 9, 2008, which is incorporated herein by reference.

### TECHNICAL FIELD OF THE DISCLOSURE

This invention relates in general to geological information analysis and, more particularly, to a method and system for collecting seismic information.

### BACKGROUND

Seismic acquisition may be accomplished using a seismic source in the water and receivers on the sea floor. The typical operation uses a seismic source in the water towed behind a boat. This source will generate pressure waves (P-waves) in the water. Data from a set of receivers on the sea floor can generate a geological model of the earth beneath the sea floor based on the generated pressure waves. The most used wave-mode is a wave that has traveled as a P-wave all the way from the source to a reflector where it is reflected upward and registered by a receiver. However, for many applications, reflected P-waves may not provide sufficient information about the underlying strata of the sea floor, its geometrical structure, or its properties.

### SUMMARY

In accordance with the present disclosure, the disadvantages and problems associated with collecting seismic information have been substantially reduced or eliminated.

In accordance with one embodiment of the present disclosure, a method for collecting seismic information includes transmitting a first pressure wave from a first location towards a floor of a body of water, wherein the first location is in close proximity to the floor. The method also includes receiving a first reflected wave at a second point, wherein the first reflected wave comprises a reflection of the first pressure wave by a reflection point beneath the floor. Additionally, the method includes receiving a second reflected wave at the second point, wherein the second reflected wave comprises a reflection of a shear wave generated as a result of the first pressure wave striking the floor.

In accordance with another embodiment of the present disclosure, a system for collecting seismic information includes a seismic source operable to transmit a first pressure wave from a first location towards a floor of a body of water, wherein the first location is in close proximity to the floor. The system also includes a seismic receiver operable to receive a first reflected wave at a second location, wherein the first reflected wave comprises a reflection of the first pressure wave by a reflection point beneath the floor. The seismic receiver is also operable to receive a second reflected wave at the second location, wherein the second reflected wave comprises a reflection of a shear wave generated as a result of the first pressure wave striking the floor.

Technical advantages of certain embodiments of the present disclosure include acquiring 4-component seismic data in a shallow-water environment which may be useful for carbonate reservoir production monitoring. The air/water interface in shallow-water environment may act as a virtual source that has a similar waveform and short duration as the original source signal. For near-offset data where the energy of converted PS-S reflects are strong, inline geophone data at shallow depths correlate well with synthetic S-wave modeling results using log data.

Other technical advantages of certain embodiments of the present disclosure include generating P-waves and S-waves simultaneously into the sea floor from the same point when a P-wave source is placed near the water/rock boundary. Inline and cross-line geophone records from the sea floor geophones can be processed and interpreted systematically as PS-S reflections due to strong P-S energy conversion at the water-sea floor interface. The P-S energy conversion disclosed may be much stronger than other converted modes such as P-P-S that are conceived and utilized by present research and practice. Thus, marine seismic sources, such as, for example, air-guns, may be used to directly and efficiently generate shear waves into the sea floor, regardless of the water depth of the sea.

Other technical advantages of certain embodiments of include the ability to emit P-waves and S-waves at approximately the same time and approximately the same location as well as the ability to record both the P-waves and the S-waves at the same position. Additionally, by firing a source in shallow water, an operator may have one real source and one virtual source (the ghost reflection at the water-air interface) interacting and functioning as a single source, thereby generating both P- and S-waves into the underground (i.e., below the sea floor) in an efficient manner.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an embodiment of a seismic information system including a ship, a seismic source, a seismic receiver, and a seismic analyzer;

FIG. 2 illustrates a particular embodiment of the seismic information system shown in FIG. 1 during operation;

FIG. 3 illustrates a particular embodiment of the seismic information system shown in FIG. 1 during operation in an alternative configuration;

FIG. 4 illustrates an embodiment of the seismic information system shown in FIG. 1 operating in generally shallow water, including a representation of symmetric P- and S-waves;

FIG. 5 is block diagram illustrating in more detail an embodiment of the seismic analyzer shown in FIG. 1, including aspects of an embodiment of the present disclosure; and

FIG. 6 is a flow chart illustrating a particular operation of the seismic information system of FIG. 1.

### DETAILED DESCRIPTION

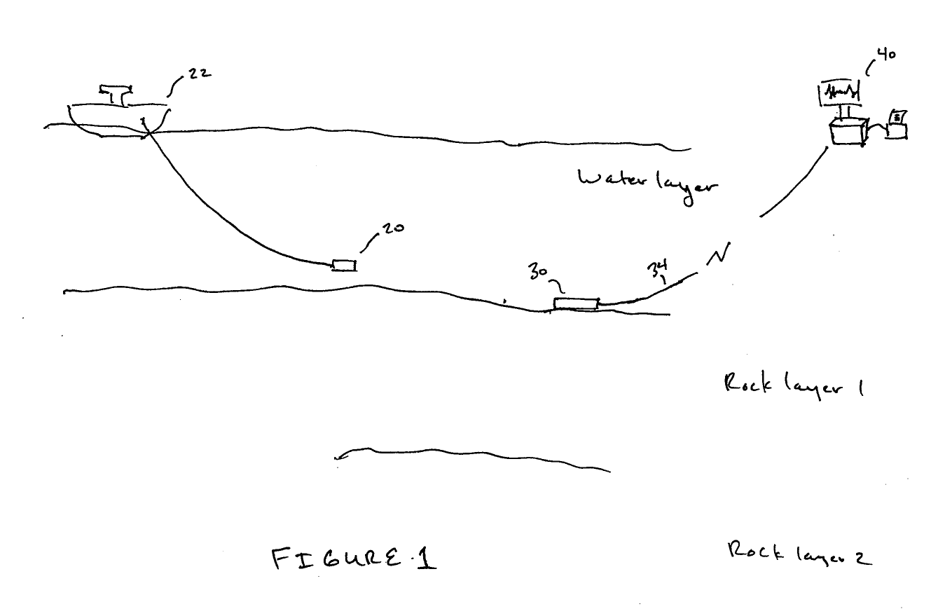

FIG. 1 illustrates a particular embodiment of seismic information system 10. Seismic information system 10 includes a seismic source 20, seismic receiver 30, and seismic analyzer 40. Seismic source 20 may generate impulses, causing waves to emanate from seismic source 20. Seismic receiver 30 receives seismic waves generated by seismic source 20 that reflect off a reflection point. Additionally, seismic receiver 30 may convert received energy waves into electronic information that is transmitted to seismic analyzer 40 for processing and analysis. Positioning seismic source 20 in appropriate locations, as discussed further below, may enable an operator to collect seismic information from P-waves and S-waves generated at a single source point.

Seismic source 20 produces controlled seismic energy in a source medium. In particular embodiments, seismic source 20 may represent an air gun comprising one or more pneumatic chambers pressurized with compressed air. The compressed air may be released to generate acoustic energy below the ocean surface. The acoustic energy may be transmitted away from seismic source 20 in the form of one or more types of waves. Seismic source 20 may alternatively represent dynamite exploded below the ocean surface, or a plasma sound source. In general, however, seismic source 20 may be any energy-producing source operable to transmit energy in the form of propagating waves. Additionally, P-waves generated by seismic source 20 may have a velocity varying from approximately between 2 and 4.5 kilometers per second.

Additionally, seismic source 20 may transmit energy as single pulses, intermittent pulses, or continuous pulses of energy. Each instance of transmission may be referred to generically as an impulse of energy. Each impulse produced by seismic source 20 may result in one or more waves that travel through a particular medium, including water and/or one or more various layers of the earth's surface. In particular embodiments, seismic source 20 may be moved or transported to various positions during operation.

For example, as shown in FIG. 1, seismic source 20 may be towed below the surface of a body of water by ship 22. In such embodiments, seismic source 20 may generate impulses at predetermined intervals while being towed. Seismic source 20 may generate impulses continuously or intermittently as seismic source 20 is being towed by ship 22. In particular embodiments, seismic source 20 may be towed at a depth well below the surface of the relevant body of water. As described further below, in particular embodiments, seismic source 20 may be towed close to the sea floor.

As another example, seismic source 20 may be installed in a first temporarily fixed position before generating impulses. For example, seismic source 20 may be installed on the sea floor, where it may generate impulses into the Earth's surface. An operator may subsequently move seismic source 20 to a second temporarily fixed position where seismic source 20 may generate additional impulses. An operator may continue moving seismic source 20 from temporarily fixed position to temporarily fixed position as additional seismic energy is generated and seismic information gathered. Although the illustrated embodiment includes a single seismic source 20, particular embodiments of seismic information system 10 may include any appropriate number and type of seismic sources 20. Seismic information system 10 may additionally include one or more seismic sources 20 that generate impulses concurrently, separately, consecutively, in combinations, or in any other appropriate manner.

Seismic receiver 30 receives seismic waves generated by seismic source 20 and reflected off reflection point 26. In particular embodiments, seismic receiver 30 may include one or more transducers that convert received wave energy into electronic or computer-readable information. Seismic receiver 30 may transmit the electronic or computer-readable information through cable 32 to seismic analyzer 40 as seismic information is received and/or detected. Additionally, seismic receiver 30 may also detect and store seismic information over a period time. Thus, the stored seismic information may be retrieved and analyzed by seismic analyzer 40 at a later point. One or more seismic receivers 30 may be disposed in a sequence and/or spaced at predetermined intervals within cable 32.

Seismic receiver 30 may represent a multi-component seismic sensor, which may include one or more geophones and/or one or more hydrophones. In particular embodiments, seismic receiver 30 represents a 4-component seismic sensor that includes a hydrophone and a 3-component geophone (i.e., 3 orthogonally-oriented geophones). The 3-component geophone may measure the particle movement of one or more reflected waves along 3-orthogonal axes. One geophone component may be oriented along an x-axis, a second geophone component may be oriented along an y-axis, and a third geophone component may be oriented along a z-axis. The hydrophone may measure the pressure variation in the water surrounding the hydrophone. In alternative embodiments, seismic receiver 30 may include only a vertically oriented geophone and a hydrophone. In general however, seismic receiver 30 may represent any seismic instrument that detects and/or records seismic information from reflected energy waves.

Seismic analyzer 40 receives seismic information generated by seismic receiver 30. In particular embodiments, seismic analyzer 40 may include one or more processors, one or more display devices, one or more input devices, and one or more output devices. Seismic analyzer 40 may be coupled, directly or indirectly, to cable 34, which enables seismic analyzer 40 to receive seismic information from one or more seismic receivers 30. Seismic analyzer 40 may subsequently process the received seismic information, display information corresponding to the received seismic information on one or more displays, or output the information to one or more output devices (e.g., a printer or seismograph). In particular embodiments, seismic analyzer 40 may utilize one or more processing sequences, including but not limited to band-pass filtering, to extract S-wave data from the received seismic information. The received seismic information, in whatever form displayed or outputted, may give an operator of seismic information system 10 information or data about a particular transmission medium or media. Seismic analyzer 40 may, in particular embodiments, be capable of indefinitely storing seismic information on one or more memory devices for subsequent processing or analysis.

Additionally, seismic analyzer 40 may represent a single component, multiple components located at a central location within seismic information system 10, and/or multiple components distributed throughout seismic information system 10. For example, in particular embodiments, seismic analyzer may represent components or modules of one or more seismic receivers 30 that are capable of communicating information between or among seismic receivers 30. In general, however, seismic analyzer 40 may represent any appropriate combination of hardware and/or software, including, but not limited to, logic encoded on tangible storage media and operable when executed on a processor and/or other computer hardware to perform the described functions, and may further include components located on seismic receivers 30 or other appropriate elements of seismic information system 10. Moreover, although FIG. 1 illustrates for purposes of example an embodiment of seismic information system 10 that includes a single seismic analyzer 40, other embodiments of seismic information system 10 may include any appropriate number of seismic analyzers 40, located in a central location or distributed throughout seismic information system 10.

In operation, ship 22 tows seismic source 20 on a cable. The cable may be of sufficient length such that seismic source 20 is positioned close to the sea floor or sea floor. As seismic source 20 is being towed, it generates impulses, forming waves that propagate through transmission media away from seismic source 20. As described further below, seismic source 20 may be towed in close proximity to the sea floor, or may be towed in shallow water to produce the desired results. In particular embodiments, the generated waves propagate radially in all directions from seismic source 20. Some generated waves may collide with the sea floor, where they continue to propagate through the Earth's surface. Seismic waves are reflected at reflection point 26, and propagate back up towards one or more seismic receivers 30 where they are detected by seismic receiver 30. Seismic receiver 30 translates the seismic waves into electronic or computer readable information, which is transmitted to seismic analyzer 40. Seismic analyzer 40 processes the received information and displays information associated with the transmission media on one or more displays and/or outputs the information on one or more output devices.

An example of this process, as implemented by a particular embodiment of seismic information system 10, is illustrated in FIG. 1. As shown in FIG. 1, seismic source 20 generates “shots,” or impulses, to create acoustic energy. At least some of the acoustic energy may manifest as waves emanating from seismic source 20. In general, two types of waves generated by seismic source 20 may include (1) pressure, or primary waves (hereinafter “P-waves”); and (2) secondary, or shear waves (hereinafter “S-waves”). P-waves move in a longitudinal direction (i.e. in a direction parallel to an original direction of propagation), and can travel through any transmission medium. S-waves move in a shear, or transverse direction (i.e., in a direction perpendicular to the original direction of propagation). When seismic source 20 generates impulses in water, P-waves are generated. Since water has no stiffness, no S-waves are generated. (The Lame parameter μ=0 for water, so the S-wave velocity, which is given by the equation V_{S}=(μ/ρ)^{-1/2}, where ρ=density, will be 0). In general, S-waves may only travel through solid bodies, since liquids do not support shear stresses. Additionally, when a plane P-wave collides with an interface at an angle other than zero (measured form the interface normal) P- and S-waves are generated in the adjacent, or next, medium. Thus, in the illustrated example, P-waves are converted to S-waves when the generated P-waves propagated through the ocean medium collide with the rock medium of the Earth's crust. As discussed further below seismic source 20 may generate waves in close proximity to the sea floor, or may generate waves in relatively shallow water to achieve the desired results.

Seismic waves generated by seismic source 20 reflect off of reflection point 26 and are transmitted back through the transmission medium to one or more seismic receivers 30. As discussed above, seismic information system 10 may include one or more seismic receivers 30 disposed along cable 34. Additionally, seismic information system 10 may include a plurality of cables 34, which may provide for distribution of seismic receivers 30 over a multi-dimensional area. Reflection point 26 may represent a point at which the impedance of the relevant transmission medium changes, or a point at which the seismic wave encounters a transmission medium that has a different impedance. As noted above, seismic receivers 30 may include a hydrophone and one or more geophones that detect the seismic waves reflected from reflection point 26. A hydrophone may detect pressure changes in water, and geophones may detect particle motion. Seismic receivers 30 may utilize a transducer to translate information about the seismic waves detected by a hydrophone and/or geophone into electronic or computer-readable information. Seismic receivers 30 may transmit the electronic or computer-readable information to seismic analyzer 40. In particular embodiments, seismic information may be transmitted to seismic analyzer 40 through cable 32 in which seismic receivers 30 are disposed.

By generating P-waves with a seismic source located close to the sea floor, seismic information system 10 may provide numerous operational benefits. For example, both P-waves and S-waves may be simultaneously generated into the sea floor from the same point. Inline and cross-line geophone records from the sea floor multi-component geophones can be processed an interpreted systematically as PS-S reflections due to strong P-S energy conversion at the water-sea floor interface. The P-S energy conversion disclosed is much stronger than other converted modes such as P-P-S. Thus, marine seismic sources, such as, for example, air-guns, may be to directly and efficiently generate shear waves in to the sea floor, regardless of the water depth of the sea.

Other operational benefits include producing the P-wave section as before, and generating the S-wave section by utilizing processing sequences, equal to those for genuine S-wave source at the floor of the sea. Moreover, P-waves and S-waves may be emitted at the same time and same point as well as being recorded at the same position. Additionally, by firing a source in shallow water, an operator may have one real source and one virtual source (the ghost reflection at the water-air interface) interacting and functioning as one source, thereby generating both P- and S-waves into the underground (i.e, below the sea floor) in an efficient manner.

As a result, seismic information system 10 may provide numerous operational benefits. Nonetheless, particular embodiments may provide some, none, or all of these operational benefits, and may provide additional operational benefits.

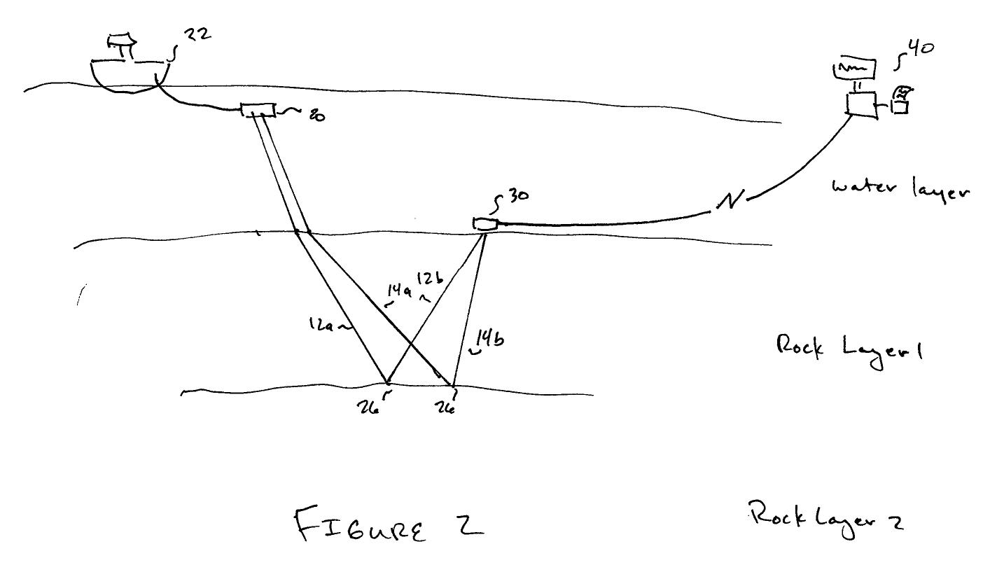

FIG. 2 illustrates a particular embodiment of the seismic information system 10 collecting seismic information. As shown in FIG. 2, seismic waves are generated near the surface of a body of water as a seismic source 20 is being pulled behind a ship 22. Arrows 12a and 14a show P-waves generated from seismic source 20 near the surface of the ocean being propagated through the Earth's surface. As illustrated by arrows 12b and 14b, P-waves generated by seismic source 20 and S-waves resulting from the conversion of these P-waves at a given geological interface are asymmetric with respect to each other. This may be due to the fact that the mode conversion point and the P-wave reflection point are not located at the same point in the medium. The reflected converted S-wave may be extracted from the data by intricate processing methods, but the converted S-wave wave mode is a weak signal, which makes the processing complicated and sometimes not successful.

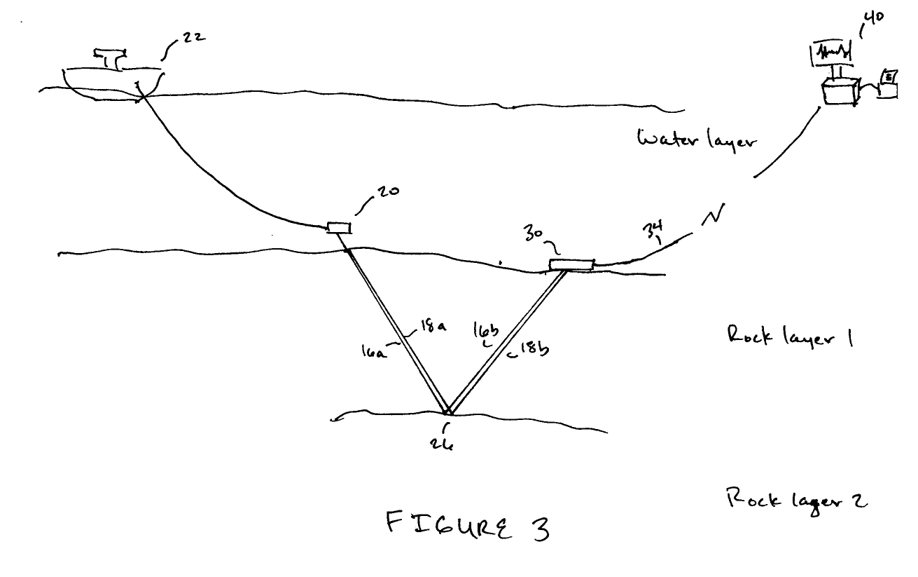

FIG. 3 illustrates a particular embodiment of seismic information system 10 in which seismic source 20 is generating seismic waves in close proximity to the sea floor. Arrow 16a shows a P-wave and arrow 18a shows an S-wave generated from seismic source 20 in close proximity to the sea floor being propagated through the Earth's surface. When seismic source 20 operates in close proximity to the sea floor, seismic source 20 may transmit P-waves along all ray-angles, forming a wave front that is nearly a spherical wavefront. When a spherical wavefront interacts with an interface (such as the sea floor), plane wavefront theory may no longer apply. Instead, the so-called Weyl integral may be used to calculate the energy transmitted into the adjacent layer (i.e., rocks in the earth's crust and mantle). Given a spherical wavefront hitting the sea floor, more energy may be converted into S-waves. Since all ray-angles may be available within a narrow area, this may give produce approximately a point S-wave source (as seen from below).

For purposes of this description, “in close proximity to the sea floor” may mean that the distance from seismic source 20 to the sea floor is substantially less than half the wavelength of the generated waves. Restated in mathematical terms, “close proximity to the sea floor” may approximate the equation z<<λ/2, where z=the vertical distance between seismic source 20 and the sea floor, and λ=the wavelength of the generated waves. For example, in particular embodiments, z is over two orders of magnitude less that λ/2 (i.e., z<λ/200).

Because of the proximity to the sea floor the generated seismic waves will approximately form a point source. This has the effect of generating symmetric wave paths, as shown by arrows 16b and 18b in FIG. 3. Consequently, seismic source 20 may produce P-wave 16a and S-wave 18a that originate from approximately the same location and at approximately the same time. Thus, the P- and S-wave may both originate from a first point and may both be detected at the same seismic receiver 30 located at a second point. Moreover, the waves may be represented as a superposition of a set of plane waves (i.e., the Weyl integral). Because of its vicinity to the geological interface, all P-wave ray-angles will be included, and consequently, those rays that best generate converted S-waves.

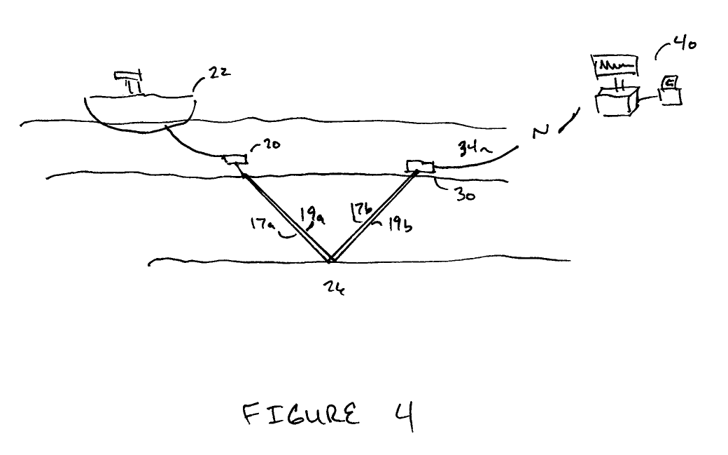

FIG. 4 illustrates an embodiment of seismic information system 10 operating in generally shallow water. As shown in FIG. 4, seismic source 20 is being towed by ship 22 in a thin water layer. Seismic source 20 generates seismic waves by transmitting energy in the form of acoustic energy impulses. Arrow 17a shows a P-wave and arrow 19a shows an S-wave generated from seismic source 20 in close proximity to the sea floor being propagated through the Earth's surface. As noted above, the resulting P-waves may be transmitted at all ray angles. However, in shallow water, the waves emanating towards the surface will be reflected back towards the sea floor off the air-water interface, since the waves cannot be transmitted into the overlying layer (the atmosphere). Thus, the P-waves generated will be trapped within a narrow cone. In particular embodiments, most of the down-going seismic energy is confined to a small area of the water/rock interface beneath the seismic source 20 with a radius of about 10 meters. The effect will approximate the effect of a circular plate of limited size vibrating vertically on the sea floor. As shown in FIG. 4, P-waves and S-waves generated at seismic source 20 may reflect off reflection point 26 and may result in symmetric wave paths, as shown by arrows P-wave 17b and S-wave 19b in FIG. 4.

The particular embodiment of seismic information system 10 illustrated in FIG. 4 may be operable to gather seismic information in water with depths of approximately 10 to 15 meters. In such embodiments, seismic source 20 may be towed behind ship 22, such that seismic source 20 operates at a depth of approximately 5 meters. In general however, particular embodiments of seismic information system 10 may collect seismic information in any generally shallow water body, whereby seismic source 20 generates acoustic energy impulses at any appropriate depth to achieve the desired result.

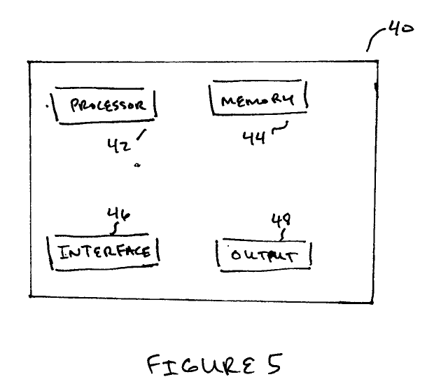

FIG. 5 is a block diagram illustrating in greater detail the contents and operation of a particular embodiment of seismic analyzer 40 shown in FIG. 1. In general, as discussed above with respect to FIG. 1, seismic analyzer 40 receives and processes seismic information received by one or more seismic receivers 30. Moreover, as discussed above, seismic analyzer 40 may represent a single component, multiple components located at a single location within seismic information system 10, and/or multiple components distributed throughout seismic information system 10. For example, seismic analyzer 40 may represent components or modules of one or more seismic receivers 30 that are capable of communicating information between or among seismic receivers 30. As shown in FIG. 4, seismic analyzer 40 may include a processor 42, a memory 44, an interface module 46, and an output module 48.

Processor 42 may represent or include any form of processing component, including general purpose computers, dedicated microprocessors, or other processing devices capable of processing electronic information. Examples of processor 42 include digital signal processors (DSPs), application-specific integrated circuits (ASICs), field-programmable gate arrays (FPGAs), and any other suitable specific or general purpose processors. Although FIG. 4 illustrates a particular embodiment of seismic analyzer 40 that includes a single processor 42, seismic analyzer 40 may, in general, include any suitable number of processors 42.

Memory 44 stores processor instructions, instructions for recording seismic information, instructions outputting seismic information, and/or any values and/or parameters that seismic analyzer 40 utilizes during operation. Memory 44 may comprise any collection and arrangement of volatile or non-volatile components suitable for storing data. For example, memory may comprise random access memory (RAM) devices, read only memory (ROM) devices, magnetic storage devices, optical storage devices, or any other suitable data storage devices. In particular embodiments, memory 44 may represent, in part, computer-readable storage media on which computer instructions and/or logic are encoded. In such embodiments, some or all the described functionality of seismic analyzer 44 may be provided by processor 42 executing the instructions encoded on the described media. Although shown in FIG. 4 as a single component, memory 44 may represent any number of memory elements within, local to, or accessible by seismic analyzer. Additionally, although shown in FIG. 4 as being located internal to seismic analyzer 40, memory 44 may represent storage components remote from seismic analyzer 40, such as elements at a Network Attached Storage (NAS), Storage Area Network (SAN), or any other type of remote storage component.

Interface module 46 couples seismic analyzer 40 to appropriate components of seismic information system 10 to facilitate communication between seismic analyzer 40 and one or more seismic receivers 30, and/or other appropriate components of target location system 10. For example, seismic analyzer 40 may receive seismic information from seismic receiver 30 through interface module 46. Additionally, interface module 46 may couple to or transmit or receiver information through one or more cables 34. In particular embodiments, interface module 46 may include or represent one or more interface cards suitable for communication over cable 34, or a connection to an electronic bus. Additionally, although FIG. 4 illustrates a particular embodiment of system controller 50 that includes a single interface module 46, seismic analyzer 40 may, in general, include any suitable number of interface modules 46. For example, seismic analyzer 40 may include an interface module 46 for each seismic receiver 30 to or from which it communicates.

Output module 48 may generate human readable information associated with seismic information received by seismic receivers 30. As noted above, seismic receivers 30 may detect waves generated by seismic source 20 and reflected off reflection point 26. In particular embodiments, seismic receiver 30 may detect P-waves and/or S-waves that are emitted at the same time and place (i.e., from seismic source 20) and received at the same time and place (i.e., at seismic receivers 30). Seismic receiver 30 coverts the wave energy information to electronic or computer-readable information, which is transmitted to seismic receiver 40. Output module 48 may convert the electronic or computer-readable information to human-readable information. In particular embodiments, output module 48 may represent or include an interface to a computer monitor display, a seismograph, a seismoscope, or a computer printer. In general however, output module 48 may convert electronic information to human-readable information in any appropriate manner, depending on the operating characteristics and environment of seismic information system 10. Additionally, simultaneous with, or as an alternative to, converting electronic seismic information to human readable information, output module 48 may store seismic information for later retrieval and/or analysis on memory 44.

In general, each of processor 42, memory 44, interface module 46, and output module 48, may represent any appropriate combination of hardware and/or software, including logic encoded on tangible media and executed on processor 42 and/or other computer hardware, suitable to provide the described functionality. Additionally, any two or more of interface module 46 and output module 48 may represent or include common elements. In particular embodiments, interface module 46 and output module 48 may represent, in whole or in part, software applications being executed by processor 42.

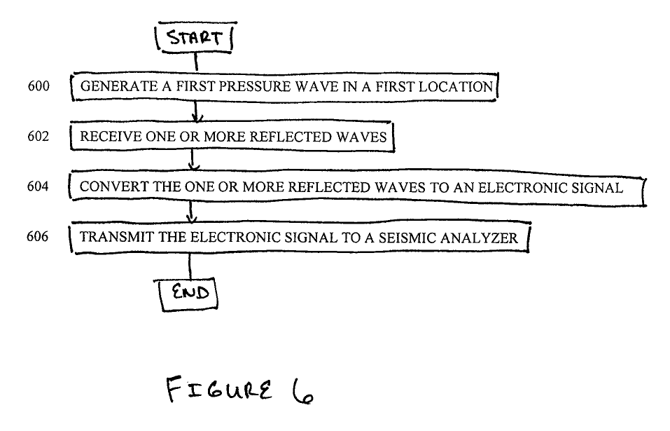

FIG. 6 is a flow chart illustrating operation of a particular embodiment of seismic information system 10 in collecting seismic information. Operation, in the illustrated example, begins at step 600 with a first pressure wave being generated in a first location. As discussed above, the first pressure wave may be generated by seismic source 20. In particular embodiments, seismic source 20 may represent an air gun, dynamite, or a plasma sound source. In general, however, seismic source 20 may be any energy-producing source operable to generate energy in the form of propagating waves. Additionally, seismic source 20 may produce energy in single pulses, intermittent pulses, or continuous pulses of energy. Additionally, in particular embodiments, the first location may be in close proximity to a sea floor. For example, in particular embodiments, the distance from seismic source 20 to the sea floor is substantially less than half the wavelength of the generated P-wave.

At step 602, one or more reflected waves may be received. In particular embodiments, the reflected waves may be received with seismic receiver 30. As discussed above, a P-wave generated by seismic source 20 may propagate through the water medium toward the sea floor (i.e., a water-rock interface). In certain embodiments, this water-rock interface converts P-waves into S-waves when the transmitted P-waves collide with the rock medium. At a point below the sea floor surface, the P-waves and S-waves may be reflected off a reflection point 26. This may occur, for example, when the impedance of the relevant transmission medium changes, or a point at which the P-waves and S-waves encounter a transmission medium that has a different impedance. The P-waves and S-waves may reflect back upward to seismic receiver 30, where they are received. Additionally, in certain embodiments, one or more P-waves and/or S-waves may be received at more than one seismic receiver 30. As a result, the reflected P-waves and S-waves may provide information about the properties of reflection point 26 and/or the surrounding earth beneath the water-rock interface. Moreover, in particular embodiments, the reflected P-waves and S-waves provide more information about reflection point 26 and/or the surrounding earth than reflected P-waves would alone.

At step 604, the one or more reflected waves are converted to an electronic signal. As discussed above, seismic receiver 30 may include a hydrophone and/or one or more geophones operable to detect P-waves and S-waves. Seismic receiver 30 may utilize a transducer to convert the detected P-waves and S-waves to an electronic signal.

At step 606, the electronic signal is transmitted to a seismic analyzer. In particular embodiments, seismic receiver 30 may be disposed within, or connected to cable 34. Cable 34 may be coupled to seismic analyzer 40 and may be operable to carry electronic signals from seismic receiver 30 to seismic analyzer 40. Seismic analyzer 40 may then receive the electronic signals, whereby it further processes, analyzes, stores and/or converts the electronic signals into human-readable output. In this manner, an operator may be able to collect seismic information.

The steps illustrated in FIG. 6 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method of collecting seismic information comprising:
transmitting a first pressure wave from a first location towards a floor of a body of water, wherein the first location is in close proximity to the floor;
receiving a first reflected wave at a second point, wherein the first reflected wave comprises a reflection of the first pressure wave by a reflection point beneath the floor; and
receiving a second reflected wave at the second point, wherein the second reflected wave comprises a reflection of a shear wave generated as a result of the first pressure wave striking the floor.

2. The method of claim 1, wherein generating the first pressure wave comprises generating an acoustic impulse with a seismic source.

3. The method of claim 1, further comprising:
converting at least one of the first and the second reflected waves to an electronic signal; and
transmitting the electronic signal to a seismic analyzer.

4. The method of claim 1, wherein the first location is separated from the floor by a distance substantially less than one-half of a wavelength of the first pressure wave.

5. The method of claim 4, wherein the first location is separated from the floor by a distance less than or equal to approximately one two-hundredth of the wavelength of the first pressure wave.

6. The method of claim 1, further comprising transmitting a second pressure wave from a third location towards the floor, wherein the third location is in close proximity to the floor;
receiving a third reflected wave at the second point, wherein the third reflected wave comprises a reflection of the second pressure wave by the reflection point; and
receiving a fourth reflected wave at the second point, wherein the fourth reflected wave comprises a reflection of a shear wave generated as a result of the second pressure wave striking the floor.

7. The method of claim 1, wherein the first location is located in generally shallow water.

8. The method of claim 7, wherein generally shallow water comprises water with a depth of approximately between 10 meters and 15 meters.

9. The method of claim 7, further comprising generating a second pressure wave in a second location, wherein the second location is in generally shallow water.

10. The method of claim 7 further comprising transmitting a second pressure wave from a third location towards the floor, wherein the third location is in close proximity to the floor and wherein the third location is in generally shallow water;
receiving a third reflected wave at the second point, wherein the third reflected wave comprises a reflection of the second pressure wave by the reflection point; and
receiving a fourth reflected wave at the second point, wherein the fourth reflected wave comprises a reflection of a shear wave generated as a result of the second pressure wave striking the floor.

11. The method of claim 7, wherein transmitting the first pressure wave comprises transmitting a first portion of the first pressure wave towards the floor and a second portion of the first pressure wave towards a surface of the body of water, wherein the second portion is reflected back towards the floor at the surface.

12. A system for collecting seismic information comprising:
a seismic source operable to transmit a first pressure wave from a first location towards a floor of a body of water, wherein the first location is in close proximity to the floor; and
a seismic receiver operable to:
receive a first reflected wave at a second location, wherein the first reflected wave comprises a reflection of the first pressure wave by a reflection point beneath the floor; and
receive a second reflected wave at the second location, wherein the second reflected wave comprises a reflection of a shear wave generated as a result of the first pressure wave striking the floor.

13. The system of claim 12, wherein the seismic source is operable to transmit the first pressure by generating an acoustic impulse.

14. The system of claim 12 further comprising a seismic analyzer, and wherein the seismic receiver is further operable to:
convert at least one of the first and the second reflected waves to an electronic signal; and
transmit the electronic signal to the seismic analyzer.

15. The system of claim 12, wherein the first location is separated from the floor by a distance substantially less than one-half of a wavelength of the first pressure wave.

16. The system of claim 15, wherein the first location is separated from the floor by a distance less than or equal to approximately one two-hundredth of the wavelength of the first pressure wave.

17. The system of claim 12, wherein the seismic source is further operable to:
transmit a second pressure wave from a third location towards the floor, wherein the third location is in close proximity to the floor; and
the seismic receiver is further operable to:
receive a third reflected wave at the second point, wherein the third reflected wave comprises a reflection of the second pressure wave by the reflection point; and
receive a fourth reflected wave at the second point, wherein the fourth reflected wave comprises a reflection of a shear wave generated as a result of the second pressure wave striking the floor.

18. The system of claim 12, wherein the first location is located in generally shallow water.

19. The system of claim 18, wherein generally shallow water comprises water with a depth of approximately between 10 meters and 15 meters.

20. The system of claim 18, wherein the seismic source is further operable to generate a second pressure wave in a second location, wherein the second location is in generally shallow water.

21. The system of claim 18, wherein the seismic source is further operable to:
transmit a second pressure wave from a third location towards the floor, wherein the third location is in close proximity to the floor and wherein the third location is in generally shallow water; and
the seismic receiver is further operable to:
receive a third reflected wave at the second point, wherein the third reflected wave comprises a reflection of the second pressure wave by the reflection point; and
receive a fourth reflected wave at the second point, wherein the fourth reflected wave comprises a reflection of a shear wave generated as a result of the second pressure wave striking the floor.

22. The system of claim 18, wherein the seismic source is operable to transmit the first pressure wave by transmitting a first portion of the first pressure wave towards the floor and a second portion of the first pressure wave towards a surface of the body of water, wherein the second portion is reflected back towards the floor at the surface.
